(19) United States
(12) Patent Application Publication
(10) Pub. No.: US 2017/0314229 A1
(43) Pub. Date: Nov. 2, 2017

(54) Frame Assembly for Heavy Duty Vehicles

(71) Applicant: Caterpillar Global Mining LLC, Tucson, AZ (US)

(72) Inventors: Sebastian Capraro, Dortmund (DE); Lutz Karrenberg, Essen (DE); Felix Hartinger, Krankenburg (DE); Mark Mors, Kamen (DE)

(73) Assignee: Caterpillar Global Mining LLC, Tucson, AZ (US)

(21) Appl. No.: 15/523,106

(22) PCT Filed: Oct. 28, 2014
(86) PCT No.: PCT/EP2014/002894

§ 371 Date: Apr. 28, 2017

(51) Int. Cl. E02F 9/08; B62D 65/02; B62D 33/077; E02F 9/16; B62D 33/063; E02F 3/30; B66C 13/54; B66C 23/62

(52) U.S. Cl. CPC E02F 9/0808; E02F 9/16; B62D 65/024; B62D 33/0633; B62D 33/077; B60Y 2200/412; B60Y 2200/416; B66C 13/54; B66C 23/62; E02F 3/308

(57) ABSTRACT

The present disclosure relates to a frame assembly of a heavy duty vehicle including an operator cabin. The frame assembly may comprise a superstructure frame having a first flange at least partially protruding from the cabin supporting frame mounting portion and having a collar and a plurality of first flange bores. The frame assembly may further comprise a cabin supporting frame having a first mounting section including a plurality of first mounting section bores, a first guiding member, and a second guiding member. The first and second guiding members may be configured to engage the collar for safely guiding the cabin supporting frame relative to the superstructure frame into a final assembling in which the plurality of first flange bores may be aligned with the plurality of first mounting section bores.

### TECHNICAL FIELD

The present disclosure generally relates to a frame assembly for heavy duty vehicles and a method for assembling a frame assembly. The present disclosure further relates to a heavy duty vehicle.

### BACKGROUND

A heavy duty vehicle, such as a large hydraulic excavator, may be equipped frame assembly including a superstructure frame and a cabin supporting frame attached to the superstructure frame. Due to the large dimensions of heavy duty vehicles, assembling of the heavy duty vehicle, especially of the frame assembly, may be challenging.

For example, EP 2 671 783 A2 discloses a cabin arrangement of the type which is intended to be mounted on a crane post of a crane. The cabin arrangement comprises a control cabin, a support frame adapted to be firmly attached to the crane post, a first linear guide arrangement connected to the control cabin and in displaceable engagement with a matching second linear guide arrangement connected to the support frame, and a lifting arrangement. The lifting arrangement includes a hydraulic cylinder telescopically extensible and retractable in such a way that the control cabin is securely connected to the crane post via the support frame.

A set of members forming an upper frame of a construction machine is disclosed in US 2014/0145471 A1. The set of members includes a center section, a left side deck, and a right side deck. The left side deck has a left deck beam. The right side deck has a right deck beam. At least one of the left or the right deck beams is adjustment deck beam. The adjustment deck beam has a contacting part that is adapted to be brought in contact with and to be welded to an external side surface of an adjustment-side longitudinal plate.

The present disclosure is directed, at least in part, to improving or overcoming one or more aspects of prior systems.

### SUMMARY OF THE DISCLOSURE

According to an aspect of the present disclosure, a frame assembly of a heavy duty vehicle including an operator cabin is disclosed. The frame assembly may comprise a superstructure frame including a cabin supporting frame mounting portion laterally disposed at the superstructure frame. The cabin supporting frame mounting portion may have a first flange at least partially protruding from the cabin supporting frame mounting portion. The first flange may have a collar and a plurality of first flange bores. The frame assembly may further comprise a cabin supporting frame configured to be mounted to the cabin supporting frame mounting portion and to support the operator cabin. The cabin supporting frame may have a first mounting section including a plurality of first mounting section bores, a first guiding member, and a second guiding member. The first and second guiding members may be configured to engage the collar for safely guiding the cabin supporting frame relative to the superstructure frame into a final assembling position during assembly. In the final assembling position, the plurality of first flange bores may be aligned with the plurality of first mounting section bores.

According to another aspect of the present disclosure, a method for assembling a cabin supporting frame to a superstructure frame of a heavy duty vehicle having an operator cabin is disclosed. The superstructure frame may include a first flange at least partially protruding from the superstructure frame in a lateral direction. The first flange may have a collar and a plurality of first flange bores. The cabin supporting frame may be configured to support the operator cabin. The cabin supporting frame may have a first mounting section including a plurality of first mounting section bores, a first guiding member, and a second guiding member. The method may comprise suspending the cabin supporting frame, lowering the cabin supporting frame thereby bringing the collar into engagement with the first and second guiding members, further lowering the cabin supporting frame into an assembling position while guiding the cabin supporting frame relative to the superstructure frame with the first and second guiding members engaged with the collar, and mounting the cabin supporting frame to the superstructure frame by inserting at least one screw into the plurality of first flange bores and the plurality of first mounting section bores.

According to another aspect of the present disclosure, a heavy duty vehicle may comprise a frame assembly according to the present disclosure, and an operator cabin mounted onto the cabin supporting frame.

Other features and aspects of this disclosure will be apparent from the following description and the accompanying drawings.

### BRIEF DESCRIPTION OF THE DRAWINGS

FIG. 1 illustrates a side view of a large hydraulic excavator including an exemplary disclosed frame assembly;

FIG. 2 is a perspective view of a superstructure frame of an exemplary disclosed frame assembly;

FIG. 3 is an enlarged view of detail III of FIG. 2 and shows a first flange of the superstructure frame;

FIG. 4 is an enlarged view of detail IV of FIG. 2 and shows a second flange of the superstructure;

FIG. 5 is a perspective view of a cabin supporting frame of an exemplary disclosed frame assembly;

FIG. 6 is a view taken along arrow VI of FIG. 5 and showing a first mounting section of the cabin supporting frame in greater detail;

FIG. 7 is a view taken along arrow VII of FIG. 5 and showing a second mounting section of the cabin supporting frame in greater detail;

FIG. 8 is a perspective view of an exemplary disclosed heavy duty vehicle prior assembling the cabin supporting frame to the superstructure frame;

FIG. 9 is a perspective view of the exemplary disclosed heavy duty vehicle of FIG. 8, with the cabin supporting frame assembled to the superstructure frame; and

FIG. 10 is a perspective view of the exemplary disclosed heavy duty vehicle of FIG. 9, with the operator cabin mounted to the cabin supporting frame.

### DETAILED DESCRIPTION

The following is a detailed description of exemplary embodiments of the present disclosure. The exemplary embodiments described therein and illustrated in the drawings are intended to teach the principles of the present disclosure, enabling those of ordinary skill in the art to implement and use the present disclosure in many different environments and for many different applications. Therefore, the exemplary embodiments are not intended to be, and should not be considered as, a limiting description of the scope of patent protection. Rather, the scope of patent protection shall be defined by the appended claims.

The present disclosure may be based at least in part on the realization that providing a guiding device at a mounting portion where a cabin supporting frame is mounted to a superstructure frame of a heavy duty vehicle may lead to a facilitated assembling process. The guiding device may ensure that the cabin supporting frame may be safely guided into a final assembling position in which the cabin supporting frame may be fixed to the superstructure frame via, for example, bolts. Particularly, in the assembling position, the bores provided at the superstructure frame and the cabin supporting frame, respectively, may be aligned to one another.

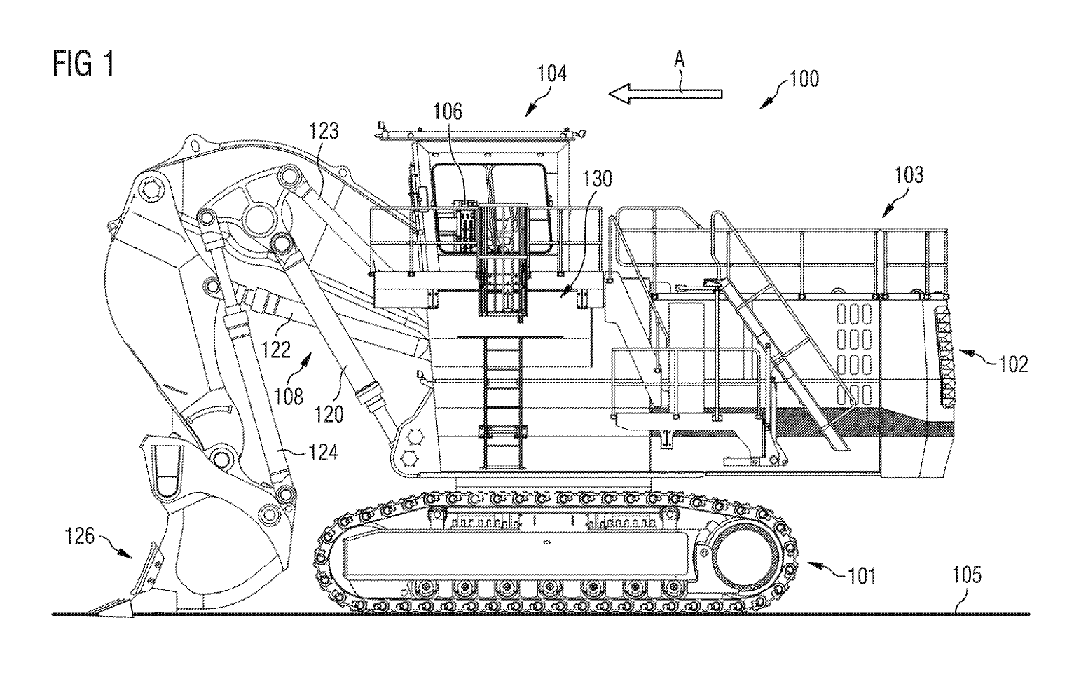

Referring now to the drawings, an exemplary embodiment of a heavy duty vehicle 100 is schematically shown in FIG. 1. The heavy duty vehicle 100 may be a hydraulic excavator, for example, a large mining excavator, or any other work machine that includes a frame assembly. The heavy duty vehicle 100 includes an engine 102. The engine 102 may provide power for the heavy duty vehicle 100 and its various components. Suitable engines may include gasoline powered engines, diesel powered engines, electrically powered engines or any combination of different types of engines. In one embodiment, the engine 102 may be a diesel engine that generates and transfers power to other components of the heavy duty vehicle 100 through a power transfer mechanism, for example, a shaft or gearbox (not shown). The engine 102 may produce a mechanical power output that may be converted to hydraulic power, for example, by one or more pumps powered by the engine 102.

The heavy duty vehicle 100 includes a uppercarriage 103 rotatably mounted on an undercarriage 101 of the rotatably mounted on an undercarriage 101 of the heavy duty vehicle 100. Specifically, the undercarriage 101 consists of an undercarriage frame with external plates attached thereto. The heavy duty vehicle 100 further includes an operator station or operator cabin 104 containing controls for operating the heavy duty vehicle 100, for example, a control panel 106. Particularly, the operator cabin 104 is mounted to and supported by a cabin supporting frame 150 (see FIG. 5) that is mounted to the uppercarriage 103 as described hereinafter.

The hydraulic system 108 may include fluid components such as, for example, hydraulic actuators or cylinders, tanks, valves, accumulators, orifices and other suitable components for producing a pressurized flow of hydraulic fluid. The hydraulic system 108 may further include fluid sources, for example, one or more tanks and/or a reservoir (not shown), and one or more hydraulic pumps, which may include variable displacement pumps, fixed displacement pumps, variable delivery pumps or other suitable pressurizing systems. The hydraulic pumps may be drivably connected to engine 102, or may be indirectly connected to engine 102 via a gear mechanism or the like. It is also contemplated that hydraulic system 108 may include multiple sources of pressurized fluid interconnected to provide hydraulic fluid for hydraulic system 108.

The hydraulic system 108 may include a plurality of hydraulic actuators, for example, one or more hydraulic actuators 120 for operating a boom of the heavy duty vehicle 100, one or more hydraulic actuators 122 for operating a stick of the heavy duty vehicle 100, one or more rods 123, one or more hydraulic actuators 124 for operating an excavator bucket 126 of the heavy duty vehicle 100, one or more hydraulic motors (not shown) for operating a swing mechanism of the heavy duty vehicle 100, and hydraulic motors associated with a left propel drive and a right propel drive of the heavy duty vehicle 100 for propelling the heavy duty vehicle 100 on a work surface 105. The swing mechanism may be operable to rotate uppercarriage 103 with respect to undercarriage 101 of the heavy duty vehicle 100. It should be appreciated that, in other embodiments, different numbers of hydraulic motors and/or hydraulic actuators may be provided for the different hydraulic circuits.

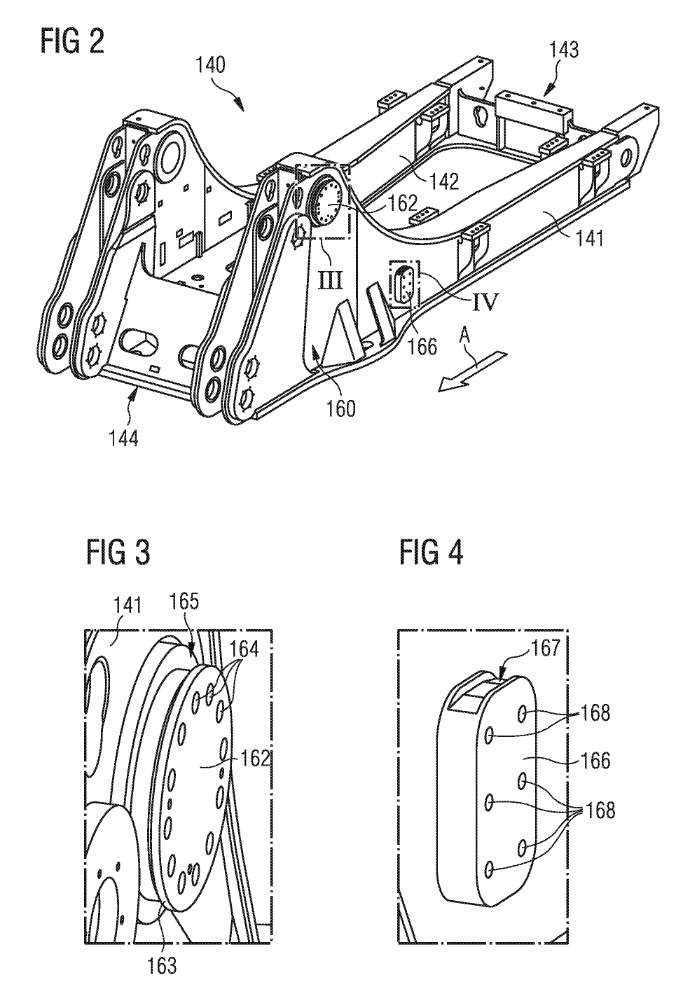

Specifically, the heavy duty vehicle 100 consists of multiple frame elements connected to one another. For example, the heavy duty vehicle 100 includes a frame assembly 130 formed by a superstructure frame 140 (see FIG. 2) and the cabin supporting frame 150 mounted to the superstructure frame 140 as described in greater detail below. In FIG. 1, the frame assembly 130 is disposed under several outer shell elements of the heavy duty vehicle 100.

Referring to FIG. 2, a perspective view of the superstructure frame 140 is illustrated. As shown, the superstructure frame 140 includes a plate-like first frame element 141 and a plate-like second frame element 142 spaced apart and connected to the plate-like first frame element 141 via third and fourth frame elements 143, 144. Each of the first, second, third, and fourth frame elements 141, 142, 143 144 may also consist of several members, such as, for instance, T-beams, double T-beams, I-beams, or customized frame elements.

The first and second frame elements 141, 142 substantially extend from the back of the heavy duty vehicle 100 to the front. The forward direction of the heavy duty vehicle 100 is indicated by an arrow A in FIGS. 1 and 2. The forward direction A is the direction of the heavy duty vehicle when driving forward. As depicted in FIG. 2, the superstructure frame 140 includes a cabin supporting frame mounting portion 160 disposed on a lateral side of the first frame element 141, particularly on the left side of the first frame element 141 when view along the forward direction A. However, in some embodiments, the cabin supporting frame mounting portion 160 may be provided on the right side of the second frame element 142 when viewed along the forward direction A.

The superstructure frame 140 includes a first flange 162 at least partially protruding from the cabin supporting frame mounting portion 160, and a second flange 166 at least partially protruding from the cabin supporting frame mounting portion 160. The first and second flanges 162, 166 may each protrude with substantially an equal distance from the cabin supporting frame mounting portion 160. As shown in FIG. 2, the first flange 162 is disposed above the second flange 166, wherein the first flange 162 is ahead the second flange 166 with respect to the forward direction A.

Referring to FIG. 3, the first flange 162 is shown in greater detail.

As shown in the exemplary embodiment, the first flange 162 is a circular protrusion attached to the superstructure frame 140 and having a collar 163. The collar 163 protrudes radially outward and extends at least partially about the circumference of the first flange 162. In some embodiments, the first flange 162 may have a rectangular shape, a triangular shape, an oval shape, or any other suitable shape. The first flange 162 further includes a plurality of first flange bores 164. In some embodiments, the plurality of first flange bores 164 may be threaded holes for receiving mounting screws.

Due to the collar 163 being spaced apart the first frame element 141, a first flange recess 165 is formed between the collar 163 and the superstructure frame 140. The first flange recess 165 at least partially extends about the circumference of the first flange 162.

Referring to FIG. 4, the second flange 166 is shown in greater detail. As shown in the exemplary embodiment, the second flange 166 is a substantially rectangular protrusion having a second flange recess 167 disposed at the top side of the second flange 166. In some embodiments, the second flange 166 may have a circular shape, a triangular shape, an oval shape, or any other suitable shape. The second flange 166 further includes a plurality of second flange bores 168. In some embodiments, the plurality of second flange bores 168 may be threaded holes for receiving mounting screws.

The first flange 162 may have a diameter ranging from about 30 cm to about 60 cm. The second flange 166 may have a height ranging from about 80 cm to about 400 cm, and a width ranging from about 100 cm to about 200 cm.

With reference to FIG. 5, a perspective view of the cabin supporting frame 150 is shown. Also in FIG. 5, arrow A indicates the forward direction with respect to the heavy duty vehicle 100. The cabin supporting frame 150 includes a cabin mounting portion 151 provided on the top side of the cabin supporting frame 150 and configured to receive the operator cabin 104 (see FIG. 1). As illustrated in FIG. 5, the cabin supporting frame 150 includes a first mounting section 152 and a second mounting section 156.

The cabin supporting frame 150 may be a heavy weight element.

The weight of the cabin supporting frame 150 may range from about 500 kg to about 8.000 kg.

The first and second mounting sections 152, 156 may be separate elements attached to the cabin supporting frame 150. In some embodiments, the first and second mounting sections 152, 156 may be integrally formed with the cabin supporting frame 150.

The relative positions of the first and second mounting sections 152, 156 to one another substantially correspond to the relative positions of the first and second flanges 162, 166 to one another, respectively. Therefore, the first mounting section 152 is disposed above the second mounting section 156, wherein the first mounting section 152 is ahead of the second mounting section 156 with respect to the forward direction A.

As shown in FIG. 5, the first mounting section 152 includes a plurality of first mounting section bores 154. The arrangement of the plurality of first mounting section bores 154 corresponds to the arrangement of the plurality of first flange bores 164, respectively.

Furthermore, the second mounting section 156 includes a plurality of second mounting section bores 158. The arrangement of the plurality of second mounting section bores 158 corresponds to the arrangement of the plurality of second flange bores 168, respectively.

As can be further seen in FIG. 5, the first mounting section 152 is a plate-like element attached to the cabin supporting frame 150 via, for instance, welding, soldering, screwing, or any other suitably fixing means. In some embodiments, the first mounting section 152 may be integrally formed with the cabin supporting frame 150. Similarly, the second mounting section 156 is a plate-like element attached to the cabin supporting frame 150 via, for instance, welding, soldering, screwing, or any other suitably fixing means. In some embodiments, the second mounting section 156 may be integrally formed with the cabin supporting frame 150.

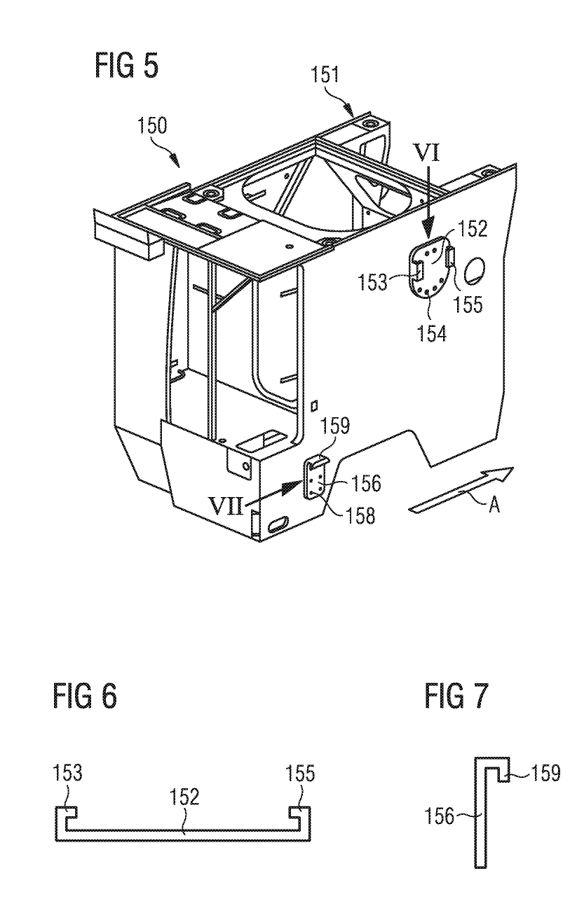

Referring to FIG. 6, the plate-like first mounting section 152 is illustrated as viewed along arrow VI of FIG. 5. As can be seen in FIG. 6, the first mounting section 152 includes a protruding first guiding member 153 and a protruding second guiding member 155. The first guiding member 153 is opposite to the second guiding member 155. As shown, the first and second guiding members 153, 155 are disposed at rearward and forward ends of the first mounting section 152 with respect to the forward direction A, respectively.

In the exemplary embodiment shown in the drawings, the first and second guiding members 153, 155 include the shape of a hook configured to engage the collar 163. In some embodiments, the first and second guiding members 153, 155 may have any shape suitable for engaging the collar 163 for safely guiding the cabin supporting frame relative to the superstructure frame 140 during assembly of the frame assembly 130.

During assembly of the frame assembly 130, the first and second guiding members 153, 155 are configured to engage the collar 163 of the first flange 162, such that a lateral movement of the cabin supporting frame 150 relative to the superstructure frame 140 is limited. Specifically, during assembly of the frame assembly 130, the first and second guiding members 153, 155 are configured to vertically guide the cabin supporting frame 150 along the superstructure frame 140 into a final assembling position, which will be described in greater detail below.

Referring, to FIG. 7, the plate-like second mounting section 156 is illustrated as viewed along arrow VII of FIG. 5. As can be seen in FIG. 7, the second mounting section 156 includes a protruding third guiding member 159. Specifically, the third guiding member 159 protrudes from an upper end of the second mounting section 156. When the cabin supporting frame 150 reaches its final assembling position relative to the superstructure frame 140, the third guiding member 159 engages the second flange recess 167, such that lateral movement of the cabin supporting frame 150 relative to the superstructure frame 140 is further limited.

As shown in the drawings, the third guiding member 159 includes the shape of a hook for engaging the second flange recess 167. In some embodiments, the third guiding member 159 may have any shape suitable for engaging the second flange recess 167 for defining a final assembling position of the cabin supporting frame 150 relative to the superstructure frame 140.

### INDUSTRIAL APPLICABILITY

In the following, a method for assembling an exemplary disclosed frame assembly 130 is described with respect to the drawings.

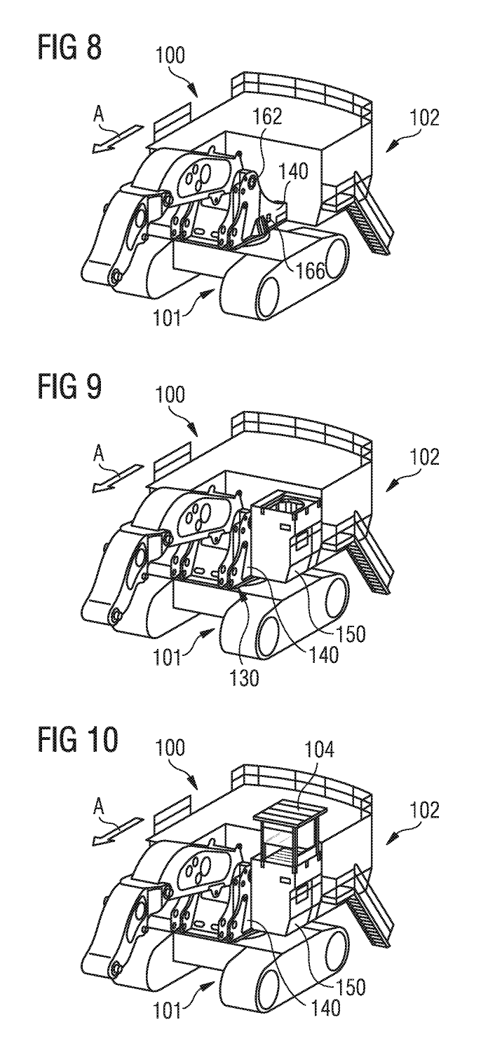

Referring to FIG. 8, the heavy duty vehicle 100 is illustrated prior assembling of the cabin supporting frame 150 to the superstructure frame 140. As can be seen in FIG. 8, the first and second flanges 162, 166 protrude from the left side of the superstructure frame 140 when viewed in forward direction A.

First, the cabin supporting frame 150 is lifted by a lifting device, such as, for example, a heavy duty crane device (not shown in the drawings). Particularly, the cabin supporting frame 150 may be suspended by the crane device utilizing a suspension apparatus, such as, for example, a wire rope. In some embodiments, the cabin supporting frame 150 is suspended in an inclined manner

Subsequently, the suspended cabin supporting frame 150 is maneuvered into the vicinity of the cabin supporting frame mounting portion 160 of the superstructure frame 140, such that the first and second mounting sections 152, 156 are disposed above the first and second flanges 162, 166, respectively.

Next, the cabin supporting frame 150 is slowly lowered, such that the first and second guiding members 153, 155 of the first mounting section 152 get into engagement with the collar 163 of the first flange 162. In such state, due to the inclined suspended cabin supporting frame 150, the third guiding member 159 of the second mounting section 156 is still out of engagement with the second mounting flange recess 167 of the second flange 166.

Subsequently, the cabin supporting frame 150 is further slowly lowered, while being vertically guided by the first and second guiding members 153, 155 engaged with the collar 163. The cabin supporting frame 150 is lowered until the third guiding member 159 engages the second flange recess 167. In particular, the third guiding member 159 engaging the second flange recess 167 may prevent the cabin supporting frame 150 prevented from tilting with respect to the superstructure frame 140.

In this state, the cabin supporting frame 150 still suspended by the crane device is in its final assembling position, in which the plurality of first flange bores 164 and the plurality of second flange bores 168 are aligned with the plurality of first mounting section bores 154 and the plurality of second mounting section bores 158, respectively.

In a final assembling step, the cabin supporting frame 150 is fixed to the superstructure frame 140 by, for example, screws inserted into the plurality of first and second mounting section bores 154, 158 and the plurality of first and second flange bores 164, 168, respectively, the latter being each provided with threads. The final assembling state of the exemplary disclosed frame assembly 130 is illustrated in FIG. 9. Then, referring to FIG. 10, the operator cabin 104 is mounted onto the cabin supporting frame 150.

Although the preferred embodiments of this invention have been described herein, improvements and modifications may be incorporated without departing from the scope of the following claims.

1. A frame assembly of a heavy duty vehicle including an operator cabin, comprising:
a superstructure frame including a cabin supporting frame mounting portion laterally disposed at the superstructure frame, the cabin supporting frame mounting portion having a first flange at least partially protruding from the cabin supporting frame mounting portion the first flange having a collar and a plurality of first flange bores; and
a cabin supporting frame configured to be mounted to the cabin supporting frame mounting portion and to support the operator cabin, the cabin supporting frame having a first mounting section including a plurality of first mounting section bores, a first guiding member, and a second guiding member, the first and second guiding members being configured to engage the collar for safely guiding the cabin supporting frame relative to the superstructure frame into a final assembling position during assembly,
wherein, in the final assembling position, the plurality of first flange bores is aligned with the plurality of first mounting section bores.

2. The frame assembly of claim 1, wherein the first guiding member is disposed opposite to the second guiding member thereby defining a guide for the collar of the first flange.

3. The frame assembly of claim 1, wherein the first guiding member is disposed at a forward end of the first mounting section with respect to a forward direction of the heavy duty vehicle, and the second guiding member is disposed at a rearward end of the first mounting section with respect to the forward direction.

4. The frame assembly of claim 1, wherein the first flange has a circular cross-section and the collar at least partially extends about the circumference of the first flange.

5. The frame assembly of claim 1, wherein the plurality of first flange bores is arranged in a circle at the first flange.

6. The frame assembly of claim 1, wherein the first mounting section is a plate like element attached to the cabin supporting frame.

7. The frame assembly of claim 1, wherein
the superstructure frame further includes a second flange at least partially protruding from the cabin supporting frame mounting portion, the second flange having a second flange recess and a plurality of second flange bores, and
the cabin supporting frame further includes a second mounting section having a third guiding member and a plurality of second mounting section bores, the third guiding member being configured to, in the assembling position, engage the second flange recess, and
in the assembling position, the plurality of second mounting section bores being aligned with the plurality of second flange bores.

8. The frame assembly of claim 7, wherein the third guiding member is disposed at a top side of the second mounting section and protruding therefrom.

9. The frame assembly of claim 7, wherein the second flange recess is disposed at a top side of the second flange.

10. The frame assembly of claim 7, wherein the second flange recess is a groove extending along a forward direction of the heavy duty vehicle.

11. The frame assembly of claim 7, wherein the second mounting section is plate like element attached to the cabin supporting frame.

12. A heavy duty vehicle comprising:
a frame assembly of claim 1, and
an operator cabin mounted onto the cabin supporting frame.

13. The heavy duty vehicle of claim 11, further comprising an undercarriage frame configured to rotatably receive the superstructure frame.

14. A method for assembling a cabin supporting frame to a superstructure frame of a heavy duty vehicle having an operator cabin, the superstructure frame including a first flange at least partially protruding from the superstructure frame in a lateral direction, the first flange having a collar and a plurality of first flange bores, the cabin supporting frame being configured to support the operator cabin, the cabin supporting frame having a first mounting section including a plurality of first mounting section bores, a first guiding member, and a second guiding member, the method comprising:
suspending the cabin supporting frame;
lowering the cabin supporting frame thereby bringing the collar into engagement with the first and second guiding members;
further lowering the cabin supporting frame into an assembling position while guiding the cabin supporting frame relative to the superstructure frame with the first and second guiding members engaged with the collar; and
mounting the cabin supporting frame to the superstructure frame by inserting at least one screw into the plurality of first flange bores and the plurality of first mounting section bores.

15. The method of claim 14, wherein the superstructure frame further includes a second flange at least partially protruding from the superstructure frame, the second flange having a second flange recess and a plurality of second flange bores, wherein the cabin supporting frame further includes a second mounting section having a third guiding member and a plurality of second mounting section bores, the method further comprising:
lowering the cabin supporting frame for bringing the third guiding member into engagement with the second flange recess in the assembling position; and
mounting the cabin supporting frame to the superstructure frame by inserting at least one screw into the plurality of second mounting section bores and the plurality of second flange bores.
